(19) United States
(12) Patent Application Publication
(10) Pub. No.: US 2003/0198477 A1
(43) Pub. Date: Oct. 23, 2003

(54) Modulated light signal processing method and apparatus

(75) Inventors: Toshiaki Kuri, Tokyo (JP); Kenichi Kitayama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Communications Research Lab. Indep. Admin. Inst., Koganei-shi (JP)

(21) Appl. No.: 10/348,770

(22) Filed: Jan. 23, 2003

(30) Foreign Application Priority Data
Apr. 23, 2002 (JP) 2002-120467

(51) Int. Cl. H04B 10/04

(52) U.S. Cl. 398/183; 398/182

(57) ABSTRACT

A modulated optical signal processing method and apparatus optically convert an optical signal to an intermediate frequency band that simplifies electrical processing after optical detection, thereby increasing the optical reception sensitivity. Either single-mode light is modulated with a first radio wave overlaid with data, or a modulated optical signal is directly generated, and the optical carrier and optical sideband contained in that modulated optical signal are transmitted, the transmitted optical carrier and optical sideband are input and the input optical carrier and optical sideband are mixed with a radio wave of a predetermined frequency and a combination of an adjacent optical carrier and optical sideband that are closer together than the frequency of the first radiofrequency electrical signal is optically selected from among a frequency-converted or frequency-unconverted optical carrier and optical sideband thus obtained and an electrical signal is detected from this selected optical signal.

### BACKGROUND OF THE INVENTION

1. Field of the Invention

The present invention relates to a modulated light signal processing method and apparatus that can be used for optical network access technologies including radio communications.

2. Description of the Related Art

Various methods are used for the signal processing used in optical communications. For example, as a simple method, it is possible to directly modulate a laser diode used as the light source, or use a light modulator to modulate the light from the laser diode and thus obtain a modulated optical signal, which is transmitted via an optical fiber. On the receiving side, this optical signal is received and a photodetector is used to convert the signal directly to an electrical signal. In addition, optical homodyne detection is also used on the receiving side, wherein the signal is not converted directly to an electrical signal by the photodetector but rather, in the same manner as on the transmitting side, detection is performed by mixing the received optical signal with an unmodulated optical signal from another light source. In addition, optical heterodyne detection is also used wherein the received optical signal is mixed with local oscillator light generated on the receiving side. In addition, in order to make use of the broadband characteristics of optical communications, a frequency-division multiplexed signal may also be used as the modulation signal.

To explain in more detail, FIG. 1 shows an example of the configuration of a conventional radio-on-fiber transmission scheme. In the configuration shown in FIG. 1, the light wave from a single-mode oscillator light source 101 is optically modulated in an optical modulator 102 by a radio signal 103 overlaid with data. The modulated light output from the optical modulator 102 is transmitted through an optical transmission path 104. The received signal light is optically amplified by an optical amplifier 105 and then noise components in unwanted bands are filtered outby an optical filter 106. The optical filter output signal indicated by 111 is optically detected by a photodetector 107 and the photodetected signal has its frequency changed using an electrical mixer 108 and electrical local oscillator 109 to obtain an intermediate-frequency signal 110 with its frequency converted to the desired band.

For this reason, in the conventional signal processing methods used for optical communications, at the time of photodetection, both a carrier and sideband are involved so it is necessary to prepare a photodetector that has a radiofrequency response characteristic equivalent to that of a GHz radio signal, and also a radiofrequency electrical mixer and electrical local oscillator must be used also to process photodetected signals.

With the signal processing methods used in conventional optical communications even in the case that the carrier and sideband are separated in frequency, at the time of photodetection, it is necessary to prepare an photodetector that has a radiofrequency response characteristic equivalent to that of the carrier frequency of a radio signal, and also, a radiofrequency electrical mixer and electrical local oscillator must also be used for the processing of the photodetected signal. For this reason, it has been difficult to improve the signal reception sensitivity. Furthermore, there is a problem in that the signal after photodetection is affected by the wavelength dispersion of the optical fiber in proportion to the square of the carrier frequency of the radio signal.

### SUMMARY OF THE INVENTION

The present invention was made in consideration of the above and has as its object to provide a modulated optical signal processing method and apparatus that, when the carrier and sideband are separated in frequency, they are converted to be closer and optically frequency-converted to an intermediate frequency band wherein electrical processing after photodetection is simplified, thereby increasing the signal reception sensitivity and also reducing the effects of the wavelength dispersion of the optical fiber.

In order to achieve the aforesaid object, the first aspect of the present invention relates to an optical signal processing method for a modulated optical carrier and optical sideband which are the input signals, comprising: a step of inputting a transmitted optical carrier and optical sideband to the input stage of a receiver, e.g. an amplifier or modulator, a step of mixing said input optical carrier and optical sideband with a radio wave of a predetermined frequency, a step of optically selecting, from among a frequency-converted optical carrier, a frequency-unconverted optical carrier, a frequency-converted optical sideband and a frequency-unconverted optical sideband obtained by this mixing, a combination of an adjacent optical carrier and optical sideband that have a smaller difference in frequency than the frequency of said radio wave, and a step of outputting an electrical signal from the optical signal contained in this selected combination.

In addition, the second aspect of the present invention relates to an optical signal processing method for modulated light in the case that a single-mode light source and optical modulator are mutually independent, comprising, first on the transmitting side: a step of modulating single-mode light with a first radio-frequency signal, a step of transmitting the optical carrier and optical sideband obtained by means of this modulation, and on the receiving side; a step of inputting the transmitted optical carrier and optical sideband to the input stage of a receiver, e.g. an amplifier or modulator, a step of mixing said input optical signal with a second radio wave of a predetermined frequency, a step of optically selecting, from among a frequency-converted optical carrier, a frequency-unconverted optical carrier, a frequency-converted optical sideband and a frequency-unconverted optical sideband obtained by this mixing, a combination of an adjacent optical carrier and optical sideband that have a smaller difference in frequency than the frequency of the first radio-frequency signal, and a step of detecting an electrical signal from the optical signal contained in this selected combination.

In addition, the third aspect of the present invention relates to an optical signal processing method for modulated light in the case that a laser diode or the like is used as a light source and this is directly modulated, comprising, on the transmitting side: a step of generating an optical signal modulated with a first radio-frequency signal, a step of transmitting the optical carrier and optical sideband contained in said modulated optical signal, and on the receiving side: a step of inputting the transmitted optical carrier and optical sideband to the input stage of a receiver, e.g. an amplifier or modulator in the same manner as above, a step of mixing the input optical carrier and optical sideband with a second radio wave of a predetermined frequency, a step of optically selecting, from among a frequency-converted optical carrier, a frequency-unconverted optical carrier, a frequency-converted optical sideband and a frequency-unconverted optical sideband obtained by this mixing, a combination of a closely adjacent optical carrier and optical sideband that have a smaller difference in frequency than the frequency of the first radio-frequency signal, and a step of outputting an electrical signal from the optical signal contained in this selected combination.

In addition, the fourth aspect of the present invention relates to an optical signal processing apparatus for modulated light in the case that a laser diode or the like is used as a light source and this is directly modulated, comprising means of inputting a transmitted optical signal to the input stage of a receiver, e.g. an amplifier or modulator, means of mixing the optical signal input to the input means with a radio wave of a predetermined frequency, an optical filter used for optically selecting, from among a frequency-converted optical carrier, a frequency-unconverted optical carrier, a frequency-converted optical sideband and a frequency-unconverted optical sideband obtained using this mixing means, a combination of an adjacent optical carrier and optical sideband that have a smaller difference in frequency than the frequency of the first radio wave, and means of detecting an electrical signal from the optical signal contained in the combination selected by this optical filter.

In addition, the fifth aspect of the present invention relates to an optical signal processing apparatus for modulated light in the case that a single-mode light source and optical modulator are mutually independent, comprising, first on the transmitting side: a light source that generates single-mode light, a modulator that modulates the light from said light source with a first radio-frequency signal, a light path that transmits the optical carrier and optical sideband obtained by means of this modulation, and on the receiving side: means of inputting the transmitted optical signal to the input stage of a receive, a mixer that mixes the input optical signal with a second radio wave of a predetermined frequency, an optical filter used for optically selecting, from among a frequency-converted optical carrier, a frequency-unconverted optical carrier, a frequency-converted optical sideband and a frequency-unconverted optical sideband obtained by this mixing, a combination of an adjacent optical carrier and optical sideband that have a smaller difference in frequency than the frequency of the first radio-frequency signal, and means of detecting an electrical signal from the optical signal contained in the combination selected by this optical filter.

In addition, the sixth aspect of the present invention relates to an optical signal processing apparatus for modulated light in the case that a laser diode or the like is used as a light source and this is directly modulated, comprising, first on the transmitting side: means of generating a modulated optical signal, a light path that transmits the optical carrier and optical sideband obtained by this modulation, and on the receiving side: means of inputting the transmitted optical signal to the input stage of a receiver, a mixer that mixes the input optical signal with a second radio wave of a predetermined frequency, an optical filter used for optically selecting, from among a frequency converted optical carrier, a frequency-unconverted optical carrier, a frequency-converted optical sideband and a frequency-unconverted optically sideband obtained by this mixing, a combination of an adjacent optical carrier and optical sideband that have a smaller difference in frequency than the frequency of the first radio-frequency signal, and means of detecting an electrical signal from the optical signal contained in the combination selected by this optical filter.

### BRIEF DESCRIPTION OF THE DRAWINGS

FIG. 1 is a structural diagram of an example of a conventional radio-on-fiber transmitter.

FIG. 2 is a structural diagram of an example of an optical signal processor for photonic downconvertion of radio-on-fiber signal.

FIG. 3 is a spectral diagram of the measured optical signal at the input of photodetector according to the present invention.

FIG. 4 is a spectral diagram of the measured optical signal after the opical freuqnecy shift according to the present invention.

FIG. 5 is a spectral diagram of the measured signal extracted by optical filter as according to the present invention.

FIG. 6 is a spectral diagram of the measured electrical signal after the photodetection in intermediate frequency band according to the present invention.

FIG. 7 is a graph of the bit error rate measured according to the present invention.

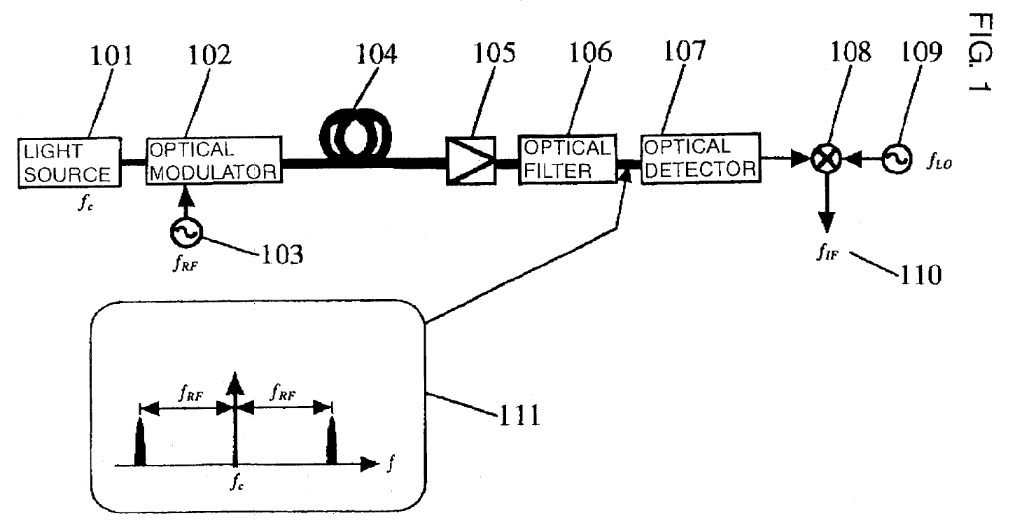

### DETAILED DESCRIPTION OF THE EMBODIMENTS

To describe the present invention in detail: a single-mode optical carrier is modulated by a radiofrequency (RF) signal containing a subcarrier signal in the RF band, the subcarrier-modulated light obtained from this modulation is transmitted, this subcarrier-modulated light is received, and so that the positions of the carrier components and sideband components in this modulated light are frequency-converted, a portion of the frequency components of the modulated light is optically extracted, photodetected and demodulated so that it is frequency-converted to the desired intermediate frequency (IF) band. The present invention has an advantage in that only the minimum necessary portion of the frequency components of the received optical signal is used in the demodulation process, so it is possible to suppress the problem of marked signal deterioration due to fiber dispersion. Here follows a description of the constitution of an embodiment of the present invention made with reference to the drawings.

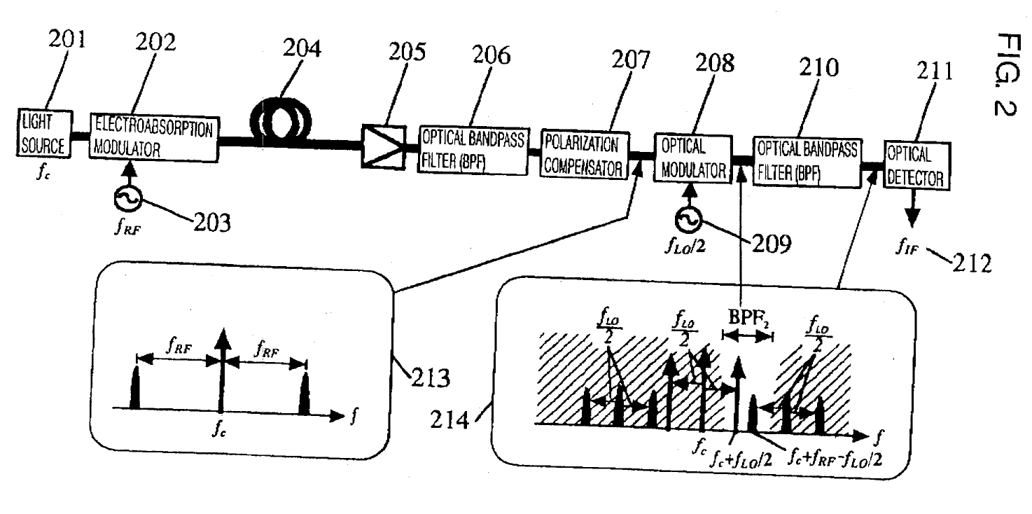

FIG. 2 is a structural diagram of an example of a signal processor for light modulated by the millimeter-wave-band subcarrier, as an embodiment of the present invention. The transmitter is to the left of the optical transmission path 204 while the receiver is to the right. In FIG. 2, the optical carrier (frequency=f_{c}) from the single-mode light source 201 is optically modulated in an electroabsorption modulator (EAM) 202 by a signal from a radio wave source 203 which supplies a first radio wave (frequency=f_{RF}) overlaid with data. The modulated light consists of an optical carrier and an optical sideband. The modulated light output from the electroabsorption modulator 202 is transmitted through the optical transmission path 204. The transmitted optical carrier and optical sideband become the received optical signal. The received optical signal is input to an optical amplifier 205, optically amplified and filtered by an optical bandpass filter (BPF) 206 to remove noise components in unwanted bands. The optical carrier and optical sideband are shown in the spectrum 213. The optical filter output signal shown in spectrum 213 is polarized by a polarization compensator 207 and then, in an optical modulator (EOM) 208, subjected to double-sideband modulation by the second radio wave which is an electrical signal (frequency=f_{LO}/2) from the electrical local oscillator 209, so both the frequencies of the carrier and sideband are down- and up-shifted by f_{LO}/2 Here, the optical modulator (EOM) 208 acts as a mixer that mixes the optical signal and the second radio wave and its output is frequency-shifted as shown in spectrum 214. Here, as the polarization compensator 207, one wherein the polarization dependence of the optical modulator (EOM) 208 is negligible can be used, so this can be omitted.

The above explanation describes the case of double-sideband modulation, and the modulation is intended to move the carrier or sideband, but in addition, phase modulation, double-sideband modulation, single-sideband modulation or frequency modulation, or frequency conversion using one of these may also be used.

In the spectrum 214, the first-order sideband components and carrier components of spectrum 213 are shifted, so for example, only the optical signals containing components with a frequency of f_{c}+f_{RF}−f_{LO}/2 and components with a frequency of f_{c}+f_{LO}/2 are extracted by an optical bandpass filter (BPF) 210, and photodetection is performed in an optical detector 211 to obtain an intermediate frequency-band signal 212 (frequency=f_{IF}/2) which is converted to the desired frequency band. Here, f_{IF}=f_{RF}−f_{LO}. In addition, if the optical bandpass filter (BPF) 210 is set so that it selects the combination of components with a frequency of f_{c}=f_{RF}+f_{LO}/2 and components with a frequency of f_{c}−f_{LO}/2, it is clear that the same intermediate frequency-band signal as in the above can again be obtained.

Moreover, in the spectrum 214 of FIG. 2, if the modulation in optical modulator (EOM) 208 is made intensity modulation, the original components with a frequency of f_{c} and the f_{RF} components can be left in their original positions while generating the components with a frequency of f_{c}+f_{RF}−f_{LO}/2, for example. At this time, by taking f_{RF} greater than f_{LO}/2, it is clear that the frequency separation between the components with a frequency of f_{c} and components with a frequency of f_{c}+f_{RF}−f_{LO}/2 can be made less than f_{RF}. Accordingly, in this case the components with a frequency off and components with a frequency of f_{c}+f_{RF}−f_{LO}/2 are selected with the optical bandpass filter (BPF) 210.

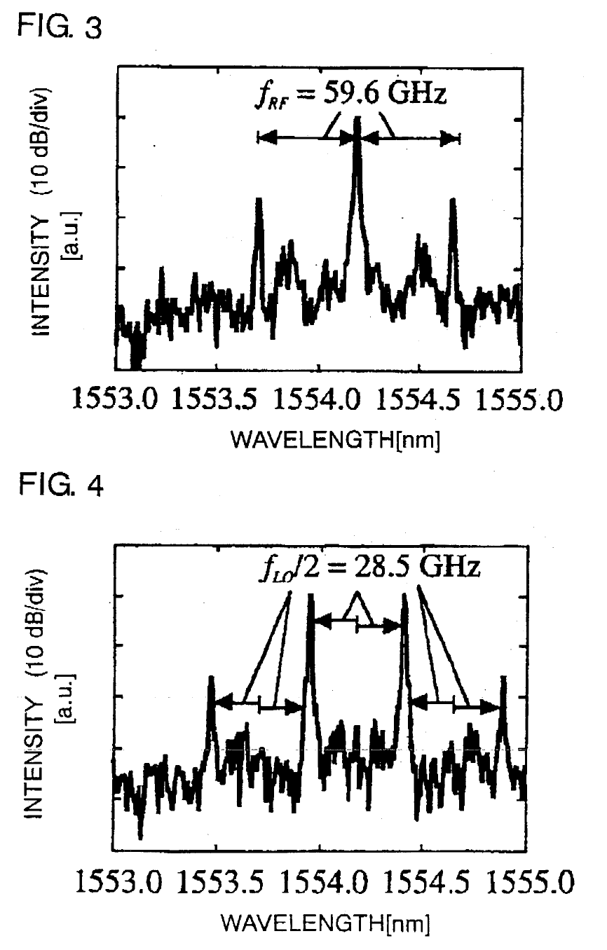

FIG. 3 shows an example of the spectrum of the received optical signal measured in an embodiment with the aforementioned constitution. Specifically, the wavelength of the optical carrier is 1554.2 nm and the frequency of the radio signal (f_{RF}) is 59.6 GHz. In addition, the modulated light signal is transmitted over a 25-km-long standard single-mode fiber (SMF).

FIG. 4 shows the spectrum of the received signal light of FIG. 3 after modulation by the electrical signal (frequency=f_{LO}/2) and conversion of the frequency of light. Here, the oscillation frequency of the electrical local oscillator (f_{LO}/2) is 28.5 GHz. The EOM used for this frequency conversion is a two-electrode LiNO₃ intensity modulator, and its bias is set so that its transmittance is a minimum (ideally, zero) so that the signal of FIG. 4 is obtained.

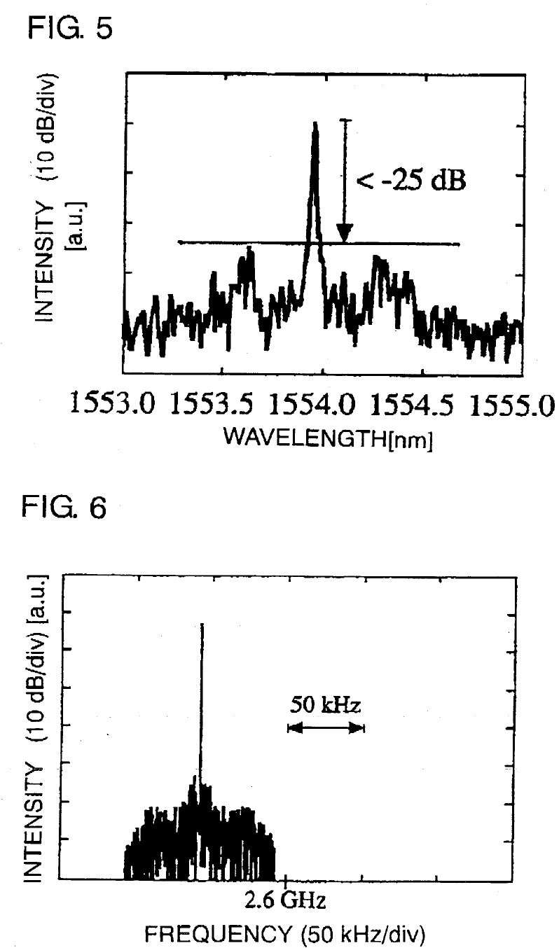

FIG. 5 shows the spectrum upon measuring the light frequency components extracted by the optical bandpass filter (BPF2) 210. The filter used as BPF2 is an arrayed waveguide (AWG) which has a 60-GHz frequency interval, and a 3-dB passband characteristics of 0.1-nm in wave-length per channel.

FIG. 6 shows the intermediate-frequency-band signal after photodetection when measured in this embodiment. The signal in FIG. 6 is 2.6 GHz and this is the aforementioned f_{IF}=f_{RF}−f_{LO} signal, equivalent to 59.6 GHz−28.5 GHz×2. In this manner, the RF signal which was 59.6 GHz on the transmitting side is convened to a lower frequency of 2.6 GHz on the receiving side by means of the manipulation by optical modulation, so the desired signals can be processed using this as the intermediate frequency. In addition, the spectral linewidth was confirmed to be 30 Hz or less, the single sideband (SSB) phase noise was confirmed to be −73 dBc/Hz or less at 10 kHz detuning.

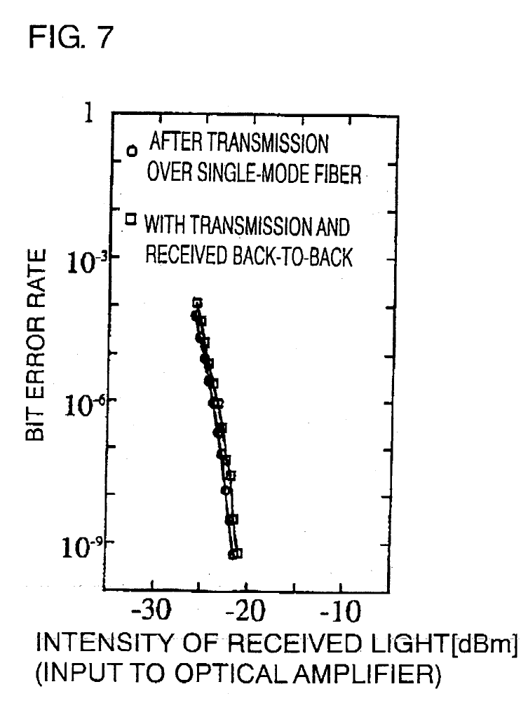

The aforementioned description presents a case in which an unmodulated signal is used as the radio signal 203 (frequency=f_{RF}), but FIG. 7 shows the bit error rate of the detected signal as a function of the received optical signal power at the photodetector input in the case of the aforementioned embodiment when a differential phase shift keying modulation millimeter-wave radio signal (carrier wave radio frequency of 59.6 GHz) with a data rate of 155.52 Mb/s is transmitted over a 25-km single-mode fiber. From FIG. 7, one can see that a bit error rate of 10⁻⁹ can easily be achieved. In addition, even in comparison to the case in which the 25-km single-mode fiber is shorted, namely in the case that the transmitter and receiver are placed back-to-back, the bit error rate is virtually unchanged so one can see that there is virtually no deterioration in the reception sensitivity.

With the present invention, on the receiving side, the input optical signal is subject to frequency conversion or modulation with a radiofrequency electrical signal of a predetermined frequency, and for example, one combination of an adjacent optical carrier and optical sideband that are closer together than the frequency of a first radiofrequency electrical signal is optically selected from among a frequency-converted or frequency-unconverted optical carrier and optical sideband obtained by this modulation or frequency conversion, and thus, the distance between the optical carrier and optical sideband is made smaller due to optical selection, and by detecting an electrical signal from this selected optical signal, the frequency conversion from the radio frequency band to the lower-frequency intermediate frequency band is performed optically. In this manner, a frequency lower than the original radiofrequency electrical signal can bc selected as the intermediate frequency, so the frequency characteristics required of the electrical circuit are relaxed. To wit, an optical detector or radiofrequency electrical element with a radiofrequency response typically has a low receiver sensitivity and relatively high noise index, so there is no need to use them and thus a superior optical communications system with high receiver sensitivity can be constructed. In addition, at the time of photodetection, only two optical frequency components of the received optical signal consisting of the carrier and one sideband are used, so the effects of the dispersion characteristics of the light path or equipment along the light path are reduced. There is also no need for the conventionally-used additional optical compensators or optical filters or other and fiber dispersion compensators that are highly dependent on the wavelength or transmission distance, and thus the problems due to the effects of fiber dispersion can be suppressed. To wit, this means that it is possible to construct a system that is flexible with respect to the wavelength of light used for the carrier and with respect to the transmission distance for optical communications.

What is claimed is:

1. An optical signal processing method comprising the steps of:
inputting a transmitted optical carrier and optical sideband,
mixing said input optical carrier and optical sideband with a radio wave of a predetermined frequency,
optically selecting, from among a frequency-convened optical carrier, a frequency-unconverted optical carrier, a frequency-converted optical sideband and a frequency-unconverted optical sideband obtained by this mixing, a combination of an adjacent optical carrier and optical sideband that have a smaller difference in frequency than the difference in frequency between said transmitted optical carrier and optical sideband, and
outputting an electrical signal from the optical signal contained in this selected combination.

2. An optical signal processing method comprising the steps of:
modulating single-mode light with a first radio wave signal,
transmitting the optical carrier and optical sideband obtained by means of this modulation,
inputting the transmitted optical carrier and optical sideband,
mixing said input optical carrier and optical sideband with a second radio wave of a predetermined frequency,
optically selecting, from among a frequency-converted optical carrier, a frequency-unconverted optical carrier, a frequency-converted optical sideband and a frequency-unconverted optical sideband obtained by this mixing, a combination of an adjacent optical carrier and optical sideband that have a smaller difference in frequency than the frequency of the first radio wave signal, and
a step of detecting an electrical signal from the optical signal contained in this selected combination.

3. An optical signal processing method comprising the steps of:
generating an optical signal modulated with a first radio wave signal,
transmitting the optical carrier and optical sideband contained in said modulated optical signal,
inputting the transmitted optical carrier and optical sideband,
mixing the input optical carrier and optical sideband with a second radio wave of a predetermined frequency,
optically selecting, from among a frequency-converted optical carrier, a frequency-unconverted optical carrier, a frequency-converted optical sideband and a frequency-unconverted optical sideband obtained by this mixing, a combination of an adjacent optical carrier wave and optical sideband that have a smaller difference in frequency than the frequency of the first radio wave signal, and
outputting an electrical signal from the optical signal contained in this selected combination.

4. An optical signal processing apparatus comprising:
means of inputting a transmitted optical signal containing an optical carrier and optical sideband,
means of mixing said input optical signal with a radio wave of a predetermined frequency,
an optical filter used for optically selecting, from among a frequency-converted optical carrier, a frequency-unconverted optical carrier a frequency-converted optical sideband and a frequency-unconverted optical sideband obtained using this mixing means, a combination of an adjacent optical carrier and optical sideband that have a smaller difference in frequency than the difference in frequency between said input optical carrier and optical sideband, and
means of detecting an electrical signal from the optical signal contained in the combination selected by this optical filter.

5. An optical signal processing apparatus comprising:
a light source that generates single-mode light,
a modulator that modulates the light from said light source with a first radio wave signal,
a light path that transmits the optical carrier and optical sideband obtained by means of this modulation,
means of inputting the transmitted optical signal,
a mixer that mixes the input optical signal with a second radio wave of a predetermined frequency,
an optical filter used for optically selecting, from among a frequency-converted optical carrier, a frequency-unconverted optical carrier, a frequency-converted optical sideband and a frequency-unconverted optical sideband obtained by this mixing, a combination of an adjacent optical carrier and optical sideband that have a smaller difference in frequency than the frequency of the first radio wave signal, and
means of detecting an electrical signal from the optical signal contained in the combination selected by this optical filter.

6. An optical signal processing apparatus comprising:
means of generating an optical signal modulated with a first radio wave signal,
a light path that transmits the optical carrier and optical sideband wave obtained by this modulation,
means of inputting the transmitted optical signal,
a mixer that mixes the input optical signal with a second radio wave of a predetermined frequency,
an optical filter used for optically selecting, from among a frequency-converted optical carrier, a frequency-unconverted optical carrier, a frequency-converted optical sideband and a frequency-unconverted optical sideband obtained by this mixing, a combination of an adjacent optical carrier and optical sideband that have a smaller difference in frequency than the frequency of the first radio wave signal, and
means of detecting an electrical signal from the optical signal contained in the combination selected by this optical filter.
